(19) United States
(12) Patent Application Publication
(10) Pub. No.: US 2008/0014546 A1
(43) Pub. Date: Jan. 17, 2008

(54) Tool for Making a Dental Filling

(75) Inventors: Gustaf Sundstrom, Stockholm (SE); Dan Ericson, Malmo (SE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: DENDEMA AKTIEBOLAG, Lidingö (SE)

(21) Appl. No.: 11/570,261

(22) PCT Filed: May 11, 2005
(86) PCT No.: PCT/SE05/00673

§ 371 Date: Dec. 8, 2006

(30) Foreign Application Priority Data
Jun. 11, 2004 (SE) 0401516-0

(51) Int. Cl. A61C 5/04

(52) U.S. Cl. 433/29

(57) ABSTRACT

The invention relates to a tool for making a dental filling of a light-hardening material. The tool comprises a tip (3) intended to be pressed down into the light-hardening material in connection with the filling of a tooth, as well as a holder (4) shaped as a sleeve with a surrounding wall (5) with an inner wall surface (14), which holder (4) is intended to receive a light guide (7). The holder comprises flexible members arranged to bear against, and by a certain force to hold, light guides of various outer dimensions. Moreover, the holder (4) is designed to press a light guide (7) placed in the holder (4) against the inner wall surface (14) of the holder, by a bearing pressure that varies along the periphery of the inner wall surface.

### TECHNICAL FIELD

The present invention relates to a tool for making a dental filling of a light-hardening material. The tool according to the invention has a holder intended to attach the tool on a light guide. Furthermore, the tool has a tip intended to be pressed down into the light-hardening material. The tool is intended especially to be used for dental filling of so called class II type.

### BACKGROUND OF THE INVENTION

Amalgam has been used for a long time for dental fillings. As amalgam contains mercury, there is often a strive today to make the fillings of other materials than amalgam. Composite materials are one of the cheaper alternatives, having the advantage of enabling application directly in the cavity. Composite materials can consist of hard, inorganic particles enclosed in a matrix of resin. Typically, non-polymerised resin contains a monomer blend, an initiator system, an inhibitor to prolong shelf stability of the non-polymerised composite, and colouring pigments. The inorganic particles, called fillers, may consist e.g. of glass, quartz, zirconium dioxide and/or amorphous silicon dioxide. The most common composite materials are light-hardening and will harden when illuminated by blue light. The filling material is illuminated by aid of a light-hardening lamp, the light of which is led by a light guide, usually a fibre optic guide, to the filling material. In for example U.S. Pat. No. 4,666,405, a tool and a method to make a filling of a light-hardening material are disclosed. The disclosed tool is made of a light-guiding material. The tool has a recess intended to hold a fibre optic handpiece, and a conical part intended to be inserted in a cavity in connection with the filling of a tooth. It is stated that the tool is suitable for fillings of so called class II type. By the term “fillings of class II type” is meant fillings made approximal to another tooth. It is important to establish a contact point between the teeth, as teeth are supposed to bear against each other with a certain pressure. For such fillings, it is common to use a so called matrix band that surrounds the tooth that is to be filled. When the filling is to take place, the filling material is placed in a drilled cavity in the tooth that is to be filled. The matrix band will then form a defining wall for the filling material. In connection with the hardening, the matrix band is pressed against the neighbouring tooth by the tool that is attached to the fibre optic tool/light guide. Accordingly, the tool is used to press at least partly in a direction towards the neighbouring tooth. Therefore, it is essential that the tool is firmly attached to the fibre optic tool/light guide. Hence, the tool must fit well on the light guide. Today, there is a large selection of light-hardening lamps and light guides for light-hardening lamps on the market. Most light guides on the market today have a circular cross-section and a diameter in the range of 6-12 mm. In recent years, there has also been a light guide with a conical end on the market. Since existing light guides have such varying outer dimensions, the corresponding tools must be made in different sizes to fit different light guides. This is because the tool must not be too loosely attached to the light guide, but must be firmly attached during use. Moreover, it should not be all together too difficult to mount the tool on the light guide.

### ACCOUNT OF THE INVENTION

The invention relates to a tool for making a dental filling of a light-hardening material. The inventive tool is made at least partly of a light-guiding material. Preferably, the entire tool is made of a light-guiding material. The tool comprises a tip intended to be pressed down into the light-hardening material in connection with the filling of a tooth, as well as a holder. The holder is formed as a sleeve with an at least partly surrounding wall having an inner wall surface and a lower stop/holder-on, such as a bottom of the sleeve, that the tip of a light guide can bear against. The holder, that is intended to receive a light guide, comprises flexible members arranged to bear against, and by a certain force to hold, light guides of various outer dimensions. Moreover, the holder is designed to press a light guide placed in the holder against the inner wall surface of the holder, by a force that varies along the periphery of the inner wall surface. In an advantageous embodiment, the holder has a reinforcement, on a portion of its periphery, as well as members arranged to press a light guide placed in the holder in a direction towards the reinforcement.

In certain embodiments, the holder can be of non-circular cross-section, such as an oval or essentially oval cross-section. Then, the holder's walls may be formed of an elastic material and designed to press a light guide positioned in the holder against the reinforcement, such that light guides of various dimensions can be held. The holder may be open in a portion of the holder's periphery opposing the position of the reinforcement, but it may also have a completely surrounding wall.

As an alternative to a resilient wall, the holder can be designed such that it is provided with at least one elastic clasp that projects from the holders inner wall and is arranged by a certain force to hold light guides of various outer dimensions, and by a surface that is sloping in relation to the longitudinal direction of the holder and connecting to the holder's inner wall surface. The sloping surface can form a transition between the holder's inner wall surface and a bottom of the holder. Then, the sloping surface tends to press a light guide against a defined portion of the holder's inner wall, when a light guide that is inserted in the holder meets the sloping surface. The sloping surface can be a curved surface, the radius of curvature of which decreasing in a direction towards the tip of the tool, i.e. in a direction towards the bottom of the holder, if it has one. In principle, embodiments are conceivable in which the sloping surface itself forms the bottom of the holder, such the entire bottom is sloping in relation to the longitudinal axis of the holder.

In an advantageous embodiment, the holder can be open in a part of the holder's periphery opposing the position of the reinforcement. In another embodiment, the holder can have a completely surrounding wall, at least along a part of its length.

Advantageously, the bottom of the holder can be a planar surface without elevations, which planar surface is perpendicular to the longitudinal direction of the holder.

In advantageous embodiments of the invention, the holder has a marking on its outside, in order to indicate the position of the reinforcement.

Advantageously, the tip can be placed below a portion of the holder's bottom that is closest to the side of the holder's wall that is provided with a reinforcement. Preferably, the tip is completely or partly formed of an elastically deformable material. Embodiments are however conceivable in which the tip is formed of a rigid material.

An upper edge of the holder can be provided with a bevelling in order to facilitate insertion of a light guide in the holder. In order to facilitate the insertion of a light guide in the holder, a rear portion of the upper edge of the holder can be provided with an elevation.

### BRIEF DESCRIPTION OF THE DRAWINGS

FIG. 1 shows the tool according to the invention during filling of a tooth.

FIG. 2 shows a tool according to prior art.

FIG. 3 illustrates one problem of the tool according to prior art.

FIG. 4 shows a tool according to the present invention, as seen from the side.

FIG. 5 shows the same tool as in FIG. 4, but as seen from the back.

FIG. 6 shows the tool according to FIGS. 4 and 5, as seen from above.

FIG. 7 shows a cross-section along D-D in FIG. 5.

FIG. 8 shows a second embodiment of the tool according to the invention, as seen from above.

FIG. 9 shows a third embodiment of the invention, as seen in perspective.

FIG. 10a shows a cross-section of the embodiment shown in FIG. 9, at insertion of a light guide.

FIG. 10b shows a cross-section of the embodiment shown in FIG. 9, after a light guide has been inserted in the holder.

FIG. 11 shows the same tool as in FIG. 9, but from a somewhat different perspective.

FIG. 12 shows the same embodiment as in FIGS. 9 and 11, but as seen from above.

FIG. 13 is a cross-section of the embodiment shown in FIGS. 9-12.

FIG. 14, 15 are schematic representations of the principle of the invention.

### DETAILED DESCRIPTION OF THE INVENTION

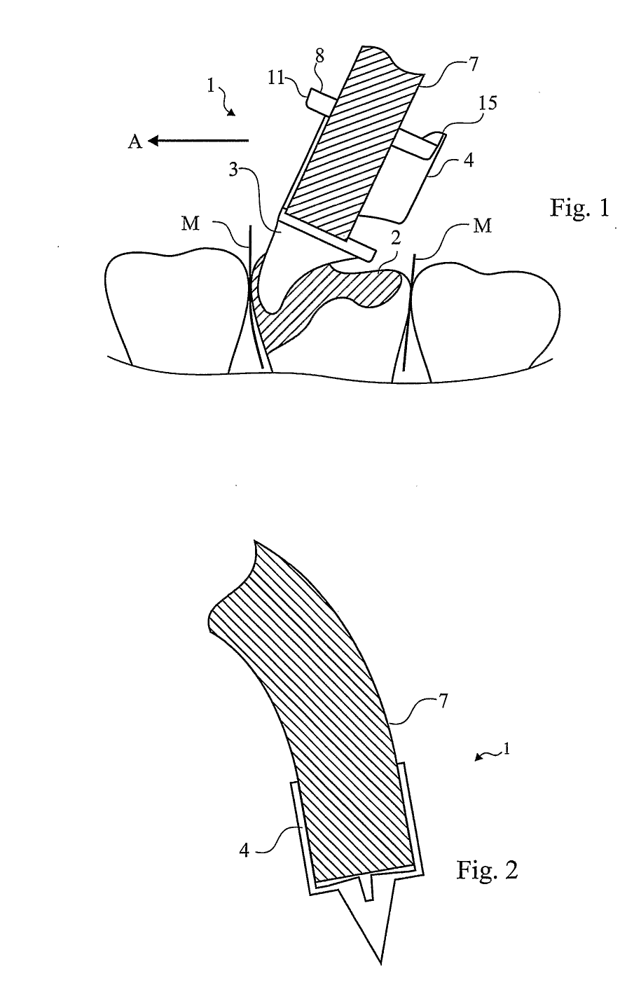

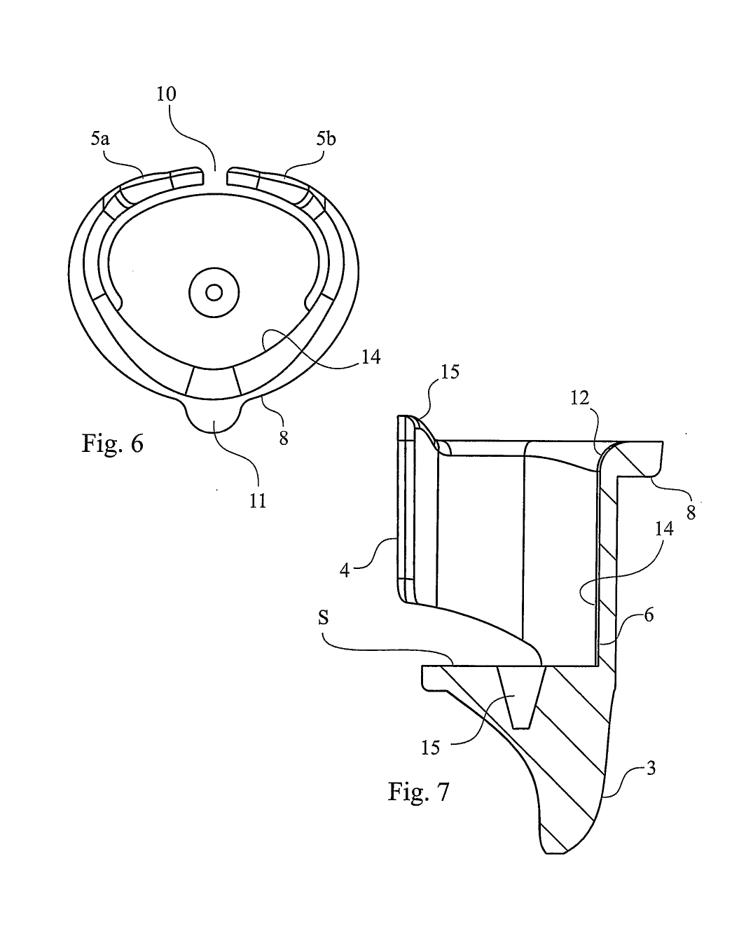

With reference to FIG. 1, a tool according to the present invention is shown during use for filling a cavity in a tooth. The tooth is shown to be surrounded by a matrix band M. A tip 3 of the tool 1 has been pressed down in a light-hardening material that is to form a filling 2. Light can then be led through the tip 3, from a light guide 7 attached to the sleeve-shaped holder 4 of the tool 1. The light is then led to the light-hardening material. During use of the tool, the tip is pressed against the neighbouring tooth in the direction of arrow A in FIG. 1. This direction will then be a working direction for the tool 1. The holder 4 is formed as a sleeve having an at least partly surrounding wall 5 with an inner wall surface 14 (see FIGS. 6 and 7), and a bottom 6. The holder is adapted to receive a light guide 7, and to hold the tool 1 on the light guide 7. It is to be understood that normally the light guide 7 is mounted on a source of light (a lamp) with a handle, and that the light guide itself constitutes an essentially rigid body. Then, the light guide 7 forms an extension of the source of light, such that the movement of the tool 1 can be controlled by the dentist gripping the handle of the light source to operate the same.

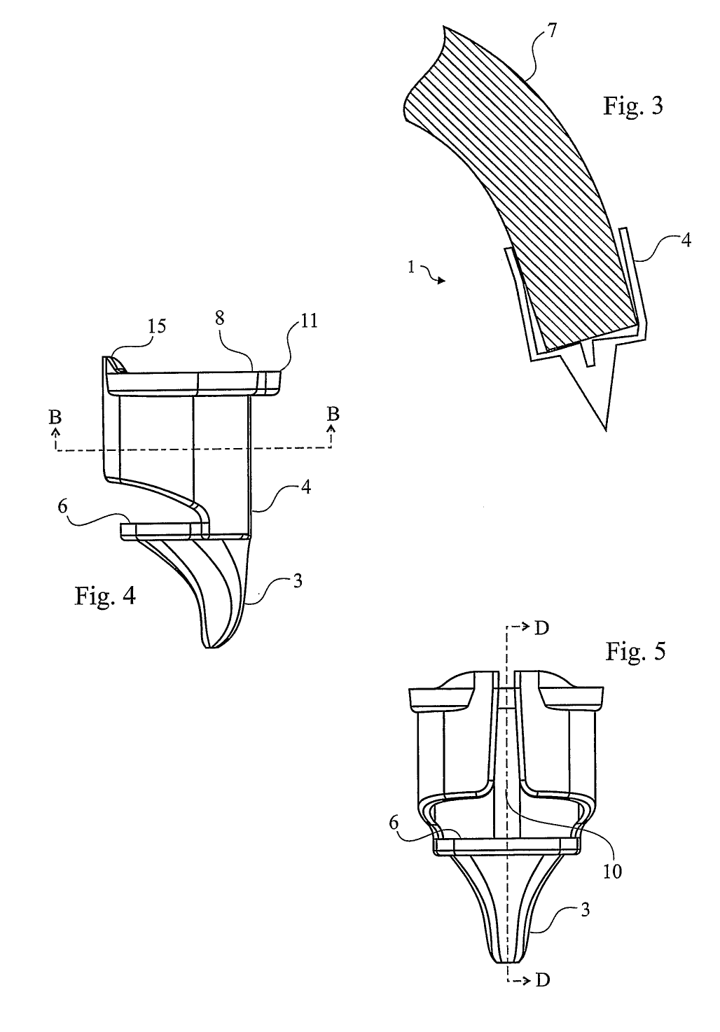

By way of introduction, the invention will now be explained with reference to the prior art according to FIGS. 2 and 3. FIG. 2 shown, in cross-section, a prior art tool 1 attached to a light guide 7. The tool has a sleeve-shaped holder 4 that fits tight about the light guide 7. According to the prior art, the holder 4 may clamp the light guide 7 since the light guide is slightly larger than the inner diameter of the holder 4. The holder 4 has a certain elasticity and clamps the light guide with a pressure that is essentially uniform along the periphery of the wall of the holder 4. FIG. 3 shows how a tool 1 has been placed on a light guide 7 having a diameter for which the holder 4 is not adapted. Then, the holder 4 will not get a firm grip of the light guide 7. This can make it difficult to fill a tooth, when the tool 1 is to press in a direction towards a neighbouring tooth. In worst case, the tool 1 might quite simply fall off the light guide, or the holder 4 will break. Therefore, one must be careful in choosing a tool 1 adapted for each individual light guide 7.

The present invention relates to a tool to be attached to light guides of various outer dimensions, yet enabling firm attachment to the light guide. The invention is based on the understanding that during the filling of a tooth, the tool 1 will not be equally loaded in all directions. If the light guide 7 bears tightly against the part of the inner wall surface of the holder 4 that in use of the tool 1 is closest to the side facing the neighbouring tooth, and facing a lower holder-on, such as a bottom face (or a part of the bottom face), and can be made to follow this inner wall and the bottom face/holder-on, it is of minor importance if the other parts of the holder 4 bear tightly against the light guide 7 or not. The underlying principle is illustrated in FIGS. 14 and 15. If two pieces, of metal e.g., i.e. a rectangular piece F and an L-shaped piece C, are pressed together according to FIG. 14, such that they bear tightly against each other, it is possible, as long as the forces bringing the pieces together remain, to turn the rectangular piece F, whereby the L-shaped piece C will follow it in the rotation symbolically indicated with arrows in FIG. 15. Therefore, if a light guide 7 is pressed both against a defined part of the wall of the holder 4, and against a lower stop of the holder, suitably a bottom of the holder, the same effect can be achieved in that the tool 1 follows the light guide 7 even if the light guide 7 does not bear against the entire inner wall surface of the holder 4.

Therefore, the tool according to the invention has been designed such that the holder comprises flexible members arranged to bear against, and by a certain force to hold, light guides of various outer dimensions, and such that the holder 4 is designed to press a light guide 7 positioned in the holder 4, against the inner wall surface 14 of the holder, by a force that varies along the periphery of the inner wall surface. The fact that the bearing force (or the bearing pressure) varies along the periphery of the inner wall surface, is to be understood as the light guide being pressed against the wall surface in-a defined direction. Then, the light guide 7 can bear against the bottom 6 of the tool (or against another lower holder-on), at the same time as it bears tight against and is pressed against a defined portion of the holder's inner wall 14, namely the portion that during the filling of a tooth is closest to the tooth neighbouring the filling. On other portions of the holder's 4 inner wall, the bearing pressure between the light guide 7 and the inner wall surface 14 can be lower or zero.

In an advantageous embodiment, the holder 4 has a reinforcement 8 at a part of its periphery. Also, the holder 4 has members 5, 5a, 5b, arranged to press a light guide 7 placed in the holder in a defined direction, and preferably in a direction towards the reinforcement 8, in a manner that will be explained in more detail in the following.

Referring to FIGS. 4-7, a first embodiment of the invention will be explained. FIG. 4 shows one embodiment of the tool according to the invention, as seen from the side. The tool 1 has a tip 3 that is placed eccentrically on the tool. Suitably, the tip 3 has a convex curvature on the side that faces outwards in a direction towards a neighbouring tooth in connection with the making of a filling. The tool 1 has a holder 4 shaped as a sleeve. FIGS. 5 and 7 show that the holder has rear opening 10. A front portion of the holder 4 is provided with a reinforcement 8. The reinforcement 8 and the opening 10 are placed opposite to each other along the periphery of the holder 4. FIG. 6 shows that the reinforcement 8 can be an upper edge portion of the wall 5, having a larger thickness. As is shown in FIG. 4 e.g., the holder 4 has an edge at its upper end. The edge is thickest on the side of the holder 4 that in use of the tool will face the neighbouring tooth and be pressed in the direction of the arrow A in FIG. 1. Accordingly, a portion of the edge has a larger thickness. The portion with a larger thickness forms a reinforcement 8. A rear portion of the holder 4 is divided in two parts 5a, 5b, by the opening 10. These parts of the wall 5 are thinner, and as the wall 5 is made of an elastic material, these parts of the holder 4 can be elastically deformed without the need of a large force. Therefore, it is easy to attach the tool 1 on light guides of various outer dimensions. When mounting the tool on a light guide 7, the rear parts 5a, 5b will however press the light guide against the thick wall reinforced portion 8. As is apparent of the figures, the holder 4 has a non-circular cross-section. Preferably, the holder 4 can be of oval or essentially oval cross-section. Hence, when the tool 1 is mounted on light guides 7 of various diameters, it will mainly be the weaker rear portions of the holder that are deformed, but the light guide 7 will all the same be pressed against the reinforcement 8, such that the light guide will bear tight against the portion of the holder 4 that is closest to the neighbouring tooth during filling. In the embodiment according to FIG. 6, the displacement is the largest on the outwardly open rear side of the holder, but the force that presses the light guide against a defined portion of the holder's inner wall may of course also originate from other portions of the holder 4, such as portions of the holder's 4 wall that are not themselves in direct contact with the light guide 7. As the reinforcement 8 is positioned on the side that during use of the tool will be closest to the tooth neighbouring the tooth to be filled, this will result in that the tool 1 follows the light guide 7 well during use. The reinforcement will also render the front side (the side facing the neighbouring tooth during filling) of the holder 4 to be stable.

On its outside, the holder 4 can have a marking 11 to indicate the position of the reinforcement 8. The marking 11 can have the shape of an elevation 11.

Suitably, the tip 3 is positioned below a portion of the holder's bottom 6 that is closest to the side of the holder's wall provided with a reinforcement 8, and thereby also closets to the side of the holder that is closest to the neighbouring tooth during filling. In advantageous embodiments, the tip 3 consists at least partly of a soft and elastically deformable material that is so soft that it is temporarily deformed during filling, i.e. during normal load. Thereby, the advantage is attained that the tip 3 adapts itself more easily to different cavities. It is to be understood that in this case, the tip 3 should be considerably more soft than the material of the holder 4. Embodiments with a tip 3 of rigid material are however conceivable.

The holder's 4 bottom 6 preferably forms a planar surface S without elevations, which planar surface S is perpendicular to the longitudinal direction of the holder 4. Thereby, the end of a light guide can bear tight against the bottom face. FIG. 7 shows however that the bottom 6 of the holder 4 can have a conical recess 25, in order to save material.

As is evident from FIG. 7, an upper edge of the holder 4 can be provided with a bevelling 12, in order to facilitate insertion of a light guide 7 in the holder. A rear portion of the holder's 4 upper edge can be provided with an elevation 15, in order to facilitate insertion of a light guide 7 in the holder 4.

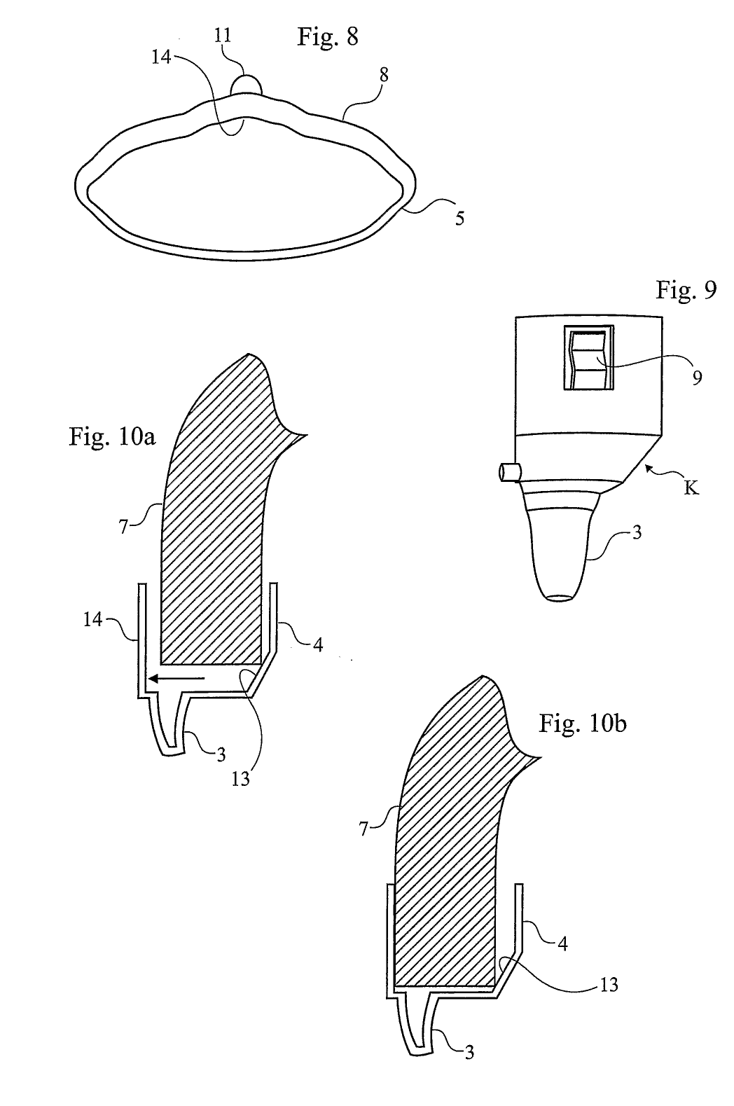

FIG. 8 shows, as seen from above, a second embodiment of the invention. In this embodiment, the holder 4 has a completely surrounding wall 5, at least along a part of its length. Just as in the embodiment according to FIG. 4-8, the front wall has a portion of the wall with a larger thickness, forming a reinforcement 8. The shown cross-section is essentially oval. A rear portion of the wall 5 is thinner, and accordingly it is easily deformed in order to receive light guides of various dimensions. Here too, the wall 5 is elastic and will press a light guide 7 forwards in a defined direction, such that the bearing pressure will vary along the periphery of the holder 4. As in the first embodiment, an elevation 11 marks which side of the holder 4 that is reinforced.

FIG. 9-13 shows a third possible embodiment of the invention. The embodiment of FIGS. 9-13 differs from the embodiments of FIGS. 4-8, by the holder 4 being provided with at least one elastic clasp 9 that projects from the holder's wall and that is arranged by a certain force to hold light guides of various outer dimensions, and by a surface 13 that slopes in relation to the longitudinal direction of the holder and forms a transition between the holder's inner wall surface and the holder's bottom. When a light guide is inserted in the holder 4, the sloping surface will press the light guide 7 against a defined portion of the holder's inner wall, as a light guide that is being inserted in the holder meets the sloping surface 13. By the light guide 7 being pressed against a defined portion of the holder's 4 inner wall, the pressure/force with which the light guide 7 is pressed against the inner wall surface 14 will vary along the periphery of the wall. In practice, it may often be expected that the pressure on certain portions of the inner wall surface is zero, while the pressure against other portions will be higher.

FIGS. 12 and 13 show that the holder 4 has two opposing elastic clasps 9 that will yield when a light guide is pressed down into the holder 4. However, the clasps 9 will hold the light guide 7 by a certain force, such that it is kept in place. When the light guide 7 is pressed down in this holder, the rear portion of the light guide 7 will meet the sloping surface 13, as is shown in FIG. 10a. Then, the light guide 7 will be pressed to the left in FIG. 10a, as is indicated by the arrow in FIG. 10a. FIG. 10b shows how the light guide 7 has come to bear against the inner wall surface 14 of the side of the holder that during filling will be closest to the neighbouring tooth. As is evident from FIG. 10b, the light guide 7 will in this embodiment not reach the bottom of the holder, not even in case of the smallest light guide 7 that is placed in the holder 4. The elastic clasps 9 will hold the light guide in a position in which it is pressed against the sloping surface 13. Therefore, the sloping surface 13 will contribute in pressing the light guide against the inner wall surface 14 on the side of the holder that will be closest to the neighbouring tooth during filling. The sloping surface 13 can be shaped as a part of a funnel, so that it constitutes a curved surface, the radius of curvature of which decreasing in a direction towards the holder's 4 bottom 6. The point on the sloping surface 13 on which the lower part of the light guide 7 rests, forms a bottom/lower holder-on for the light guide 7, such that the light guide is supported both downwards and in a direction towards the inner wall 14, just as in the other embodiments.

As mentioned above, it may be advantageous if the bottom of the holder 4 is planar, without elevations. Embodiments are conceivable however, in which the bottom of holder 5 has an elevation, such as a convex elevation. This is particularly, but not only, the case for the embodiment of FIGS. 9-13.

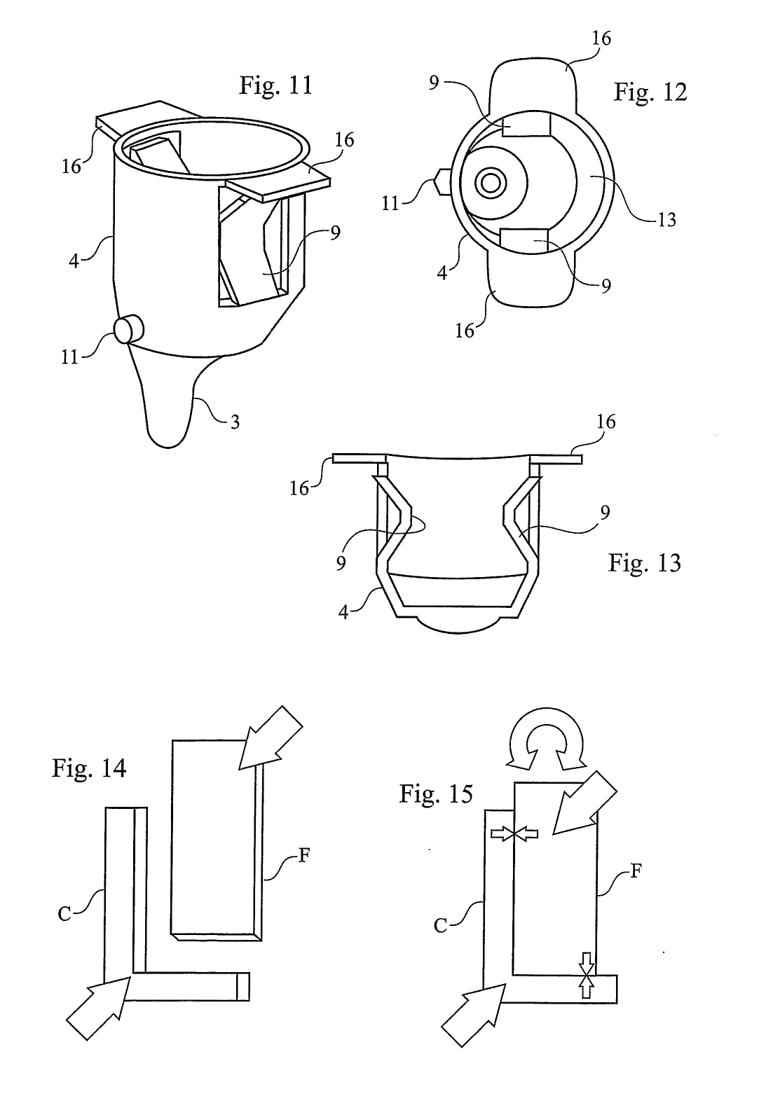

As is shown in FIGS. 11, 12 and 13, the tool 1 may, along the upper edge of the holder 4, be provided with a projecting handle 16 that a user may grip when the tool 1 is to be attached on or removed from a light guide 7.

By the invention, the advantage is attained, among other things, that one and the same tool can be used for light guides of various dimensions, at the same time as the tool is firmly attached on the light guide during use.

1-14. (canceled)

15. A tool for use in making a dental filling, the dental filling being made of a light-hardening material, the tool comprising:
a tip for pressing into the light-hardening material; and
a holder for engagingly receiving any of at least two light guides, the first light guide having a first outer dimension and the second light guide having a second outer dimension;
wherein the first outer dimension and the second outer dimension are different.

16. The tool of claim 15 wherein the holder comprises:
a wall with an inner wall surface for bearing pressure against a light guide received in the holder; and
at least one flexible member for bearing pressure against the received light guide.

17. The tool of claim 16, the holder further comprising a reinforcement at a portion of its periphery, wherein the at least one flexible member of the holder is arranged to press the received light guide in a direction toward the reinforcement.

18. The tool of claim 16 wherein the holder has a non-circular cross-section.

19. The tool of claim 16 wherein at least a portion of the wall is formed of an elastic material.

20. The tool of claim 18 wherein the holder includes an opening in its periphery disposed in opposing relationship to the reinforcement.

21. The tool of claim 16, further comprising a surface sloping in relation to the longitudinal direction of the holder, wherein the holder further comprises at least one elastic clasp projecting from its inner wall surface, and wherein the received light guide is pressed, at least partly by the elastic clasp, between the sloping surface and a portion of the inner wall surface.

22. The tool of claim 21, wherein the sloping surface is a curved surface having a radius of curvature which decreases in a direction toward the tip of the tool.

23. The tool of claim 16 wherein the holder further comprises a bottom that is at least partly formed from a planar surface that is perpendicular to a longitudinal direction of the holder.

24. The tool of claim 16 wherein the holder further comprises a beveled upper edge for facilitating reception of the light guide.

25. The tool of claim 16 wherein the holder further comprises an upper edge with an elevated portion for facilitating reception of the light guide.

26. The tool of claim 17 wherein the holder comprises a marking on its outer surface for indicating the position of the reinforcement.

27. The tool of claim 15 wherein the tip is at least partly formed of an elastically deformable material.

28. The tool of claim 16 wherein the wall completely surrounds the received light guide at least along a portion of holder's length.
